(19) United States
(12) Patent Application Publication
(10) Pub. No.: US 2005/0029005 A1
(43) Pub. Date: Feb. 10, 2005

(54) Harness fixing protector

(75) Inventors: Hiroaki Arai, Shizuoka (JP); Toshiyuki Tsutsumi, Aichi (JP)

Correspondence Address: SUGHRUE MION, PLLC, 2100 PENNSYLVANIA AVENUE, N.W., SUITE 800, WASHINGTON, DC, 20037, US

(73) Assignee: YAZAKI CORPORATION

(21) Appl. No.: 10/913,496

(22) Filed: Aug. 9, 2004

(30) Foreign Application Priority Data
Aug. 7, 2003 (JP) P2003-289202

(51) Int. Cl. H01R 4/66

(52) U.S. Cl. 174/72 A

(57) ABSTRACT

A harness fixing protector includes a base member which has fixing portions for fixing the base member to an attachment portion at both ends thereof and a cover member which is attached to the base member. The base member has a first harness inserting portion for inserting and fixing a first wire harness and a second harness inserting portion for holding a second wire harness so as to allow a movement of the second wire harness in a length direction thereof.

### BACKGROUND OF THE INVENTION

The present invention relates to a harness fixing protector for wiring and fixing a wire harness to such as a car body.

Various kinds of harness fixing protectors (called briefly as “protector” hereafter) have been used, for example, to wiring and fixing wire harnesses to car bodies.

FIG. 6 shows a related protectors (see, for example, JP-A-11-196517 (pp. 2, 3 and FIG. 1)).

This protector 51 includes a base 52 made of synthetic resin, a cover 53 made of synthetic resin engaged with the base 52, and collars 55 made of metal attached with brackets 54 at both sides of the base 52.

The base 52 has three harness inserting grooves 56 in parallel in response to three pieces of wire harnesses, and half-ring shaped brims 57 for fixing the harnesses at ends of the respective harness inserting grooves 56, while the cover 53 has half-ring shaped brims 58 in response to the respective harness inserting grooves 56, and both brims 57, 58 are opposite to compose ring shaped harness fixing portions.

The base 52 is provided at both ends with brackets 54 as fixing portions to the car body, and attached with ring shaped collars 55 in both brackets 54. The collar 55 includes a circular brim 55b of large diameter and a cylindrical brim 55a of small diameter.

FIG. 7 shows a condition of fixing three pieces of wire harnesses 21 to 23 to the car body 24 by use of the above mentioned protector 51.

Each of the wire harnesses 21 to 23 includes plural wires and the synthetic resin made corrugated tubes of the outer circumferential side for protecting the wires. The corrugated tube includes alternately arranging circumferential concave grooves (circumferential grooves) and convex projections in the length direction of the wire serving as protection of the wire and insurance of flexibility thereof.

The wire harnesses 21 to 23 are inserted into the harness inserting grooves 56 (FIG. 6) of a protector base 52 to close the cover 53, and the brims 57, 58 of the base 52 and the cover 53 enter into the concave groove of the corrugated tubes, so that the wire harnesses 21 to 23 are fixed immovably in the length direction. Under the condition of the wire harness assembled body 61, the wire harnesses 21 to 23 are wired along the car body 24, and the protector 51 is fixed to the car body. In such a manner, the wire harnesses 21 to 23 are fixed to the car body 24.

The protector 51 is fixed in that the stud bolts 25 provided to the car body 24 are inserted in the collars 55 of the brackets 54 (inserting the stud bolt 25 into the hole of the collar 55), and bolts 25 are screwed with nuts 26 and tightened.

However, in the above related protector, when the plurality of wire harnesses 21 to 23 are linearly wired and fixed in the length direction of the wall 62 of the car body, no problem occurs, but in case the wire harnesses 21 to 23 are bent and wired from the wall 62 to a transverse wall 63, or in case the wire harnesses 21 to 23 are bent and wired from the transverse wall 63 to a further transverse wall 64, owing to rigidity of the plural wire harnesses 21 to 23, bending force or twisting force acts on the protector 51, it is difficult to insert the stud bolt 25 of the car body 24 in the collar 55 of the bracket 54 of the protector 51, and grate force is required to correct the positions of the protectors 25, and fixing workability of the protector 51 to the car body 24 is decreased.

### SUMMARY OF THE INVENTION

It is therefore an object of the present invention to provide a harness fixing protector which enables to fix a plurality of wire harnesses to such as the car body by bending and wiring at good working efficiency.

In order to achieve the above object, according to the present invention, there is provided a harness fixing protector, comprising:
a base member, which has fixing portions for fixing the base member to an attachment portion at both ends thereof; and
a cover member, which is attached to the base member;
wherein the base member has:
   a first harness inserting portion for inserting and fixing a first wire harness; and
   a second harness inserting portion for holding a second wire harness so as to allow a movement of the second wire harness in a length direction thereof.

With the above mentioned structure, one sided first harness inserting portion is inserted with the wire harness, while the second harness inserting portion is inserted with the other wire harnesses. Under this condition, the cover member is attached, and the first harness inserting portion and the second harness inserting portion are respectively closed with the cover member, and become harness inserting holes. Under this condition, the respective wire harnesses are wired to attaching side of the car body, and the protector is fixed to the attaching side with bolts.

At this time, even if the bending force or twisting force acts on the protector in that the wire harnesses are bent and wired, since the respective wire harnesses are movable in the length direction in the first harness inserting portion or the second harness inserting portion (the protector is movable following the wire harness), dislocation between the fixing portions and the attaching side is absorbed, and both fixing portions are easily and securely positioned to the attaching side of the car body.

Also, even if the bending force or twisting force acts on the protector when wiring the wire harness, since the dislocation of the protector can be easily corrected along each of the wire harnesses, the protector can be easily and steadily fixed to the attaching side of the car body, and the wiring workability of the wire harness to the bending force or twisting force is heightened.

Preferably, the first harness inserting portion has a harness fixing portion to fix the first wire harness.

With the above mentioned structure, the first harness inserting portion is fixed with the wire harness, while the second harness inserting portion is not fixed but inserted with the other wire harnesses. Under this condition, the cover member is attached, and the first harness inserting portion and the second harness inserting portion are respectively closed with the cover member, and become harness inserting holes. Under this condition, the respective wire harnesses are wired to attaching sides of the car body, and the protector is fixed to the attaching side with bolts.

At this time, even if the bending force or twisting force acts on the protector by bending to wire the wire harnesses, since positioning is made at the attaching side of the car body on the basis of the fixing portion at the side of first harness inserting portion, and the fixing portion at the side of the second harness inserting portion is turned on the basis of the fixing portion at the side of first harness inserting portion so that dislocation can be absorbed, both fixing portions are easily and securely positioned to the attaching side. This is because the second wire harness can freely move in the second harness inserting portion.

Also, even if the bending force or twisting force acts on the protector when wiring the wire harness, since one of the fixing portions of the protector can be absorbed as to the dislocation caused in the turning direction around the other fixing portion of the first harness inserting portion, the protector can be easily and steadily fixed to the attaching side of the car body, and the wiring workability of the wire harness to the bending force or twisting force is heightened.

Preferably, the second harness inserting portion, through which a plurality of wire harnesses is passed, is greater than the first harness inserting portion in width.

With the above mentioned structure, since the plurality of wire harnesses are inserted movably in the length direction in the second harness inserting portions, when the wire harness is wired as being bent to the attached side of the car body, large bending force or twisting force (resiliency) caused by bending the plural wire harnesses is escaped through the wide second harness inserting portion, so that the protector is prevented from action of this large force.

Also, since the protector is not added with large resiliency caused by the bending force or twisting force of the plural pieces of wire harnesses, the protector can be easily and steadily fixed to the attaching side of the car body.

Preferably, the first harness inserting portion and the second harness inserting portion are adjacent through a partition wall.

With the above mentioned structure, the wire harness within the first harness inserting portion is positioned and protected by the partition wall without receiving any influences by the wire harness moving in the second harness inserting portion, and at the same time, the wire harness in the second harness inserting portion may smoothly move in the length direction without frictional resistance caused by contacting with the wire harness in the first harness inserting portion.

Also, the positioning of the wire harness and the protector can be secured by the partition wall in the first harness inserting portion, and the position of one of the fixing portions as the basis of attaching the protector is correctly secured, and the other wire harness can move smoothly within the second harness inserting portion without contacting the wire harness in the first harness inserting portion, the protector can be further easily and steadily fixed to the attaching side of the car body.

Preferably, the first harness inserting portion is a groove. The cover member has a harness fixing portion which is opposed to the groove.

With the above mentioned structure, the wire harness is steadily positioned and fixed in the first harness inserting portion by the harness fixing portions of the base member and the cover member.

Also, since the wire harness is steadily positioned and fixed by both harness fixing portions of the base member and the cover member in the first harness inserting portion, the protector can be further steadily fixed at the fixing portion to the attaching side of the car body.

Preferably, the harness fixing portion is a projection which is engaged with a circumferential groove of a corrugated tube of the wire harness.

With the above mentioned structure, the corrugated tubes having the plurality of the circumferential grooves in equal pitches in parallel are easily and correctly positioned and fixed by the projections such as the brims of the protector. The corrugated tubes are positioned immovably in the length direction and movably in the circumferential direction by the projections, so that twist of the corrugate is absorbed.

Also, the wire harness can be easily and steadily positioned to the protector by making use of the circumferential grooves of the corrugated tubes of the wire harness, and concurrently twist of the corrugate is absorbed, and the wiring of the wire harness can be heightened.

Preferably, one of the fixing portions at the side of the first harness inserting portion has a circular hole. The other fixing portion at the side of the second harness inserting portion has a oblong hole.

With the above mentioned structure, one of the fixing portions of the protector is positioned at the attaching side of the car body on the basis of the circular hole, and when the dislocation of the other fixing portion of the protector is absorbed in the turning direction, the dislocation is much absorbed by the oblong hole of the other fixing portion.

Also, the dislocation of the other fixing portion of the protector is exactly absorbed, and the protector is more heightened in the positioning and fixing workability to the attaching side of the car body.

### BRIEF DESCRIPTION OF THE DRAWINGS

The above objects and advantages of the present invention will become more apparent by describing in detail preferred exemplary embodiments thereof with reference to the accompanying drawings, wherein:

FIG. 1 is disassembled view showing a protector according to a first embodiment of the invention;

FIG. 2 is a perspective view of setting up the protector;

FIG. 3 is a plan view showing the condition of inserting and fixing the wire harness into the protector;

FIG. 4 is a disassembled view showing a protector according to a second embodiment of the invention;

FIG. 5 is a perspective view of setting up the protector;

FIG. 6 is a perspective view showing a related protector; and

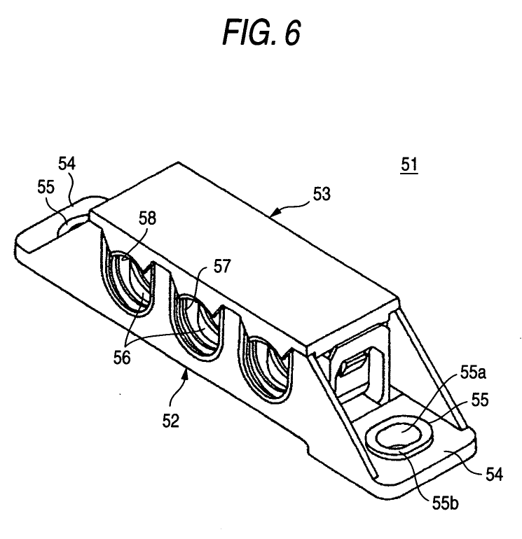

FIG. 7 is a perspective view showing the condition of wiring the wire harness to the car body and attaching the related protector.

### DETAILED DESCRIPTION OF THE PREFERRED EMBODIMENTS

In the following description, explanation will be made in detail to embodiments of the invention.

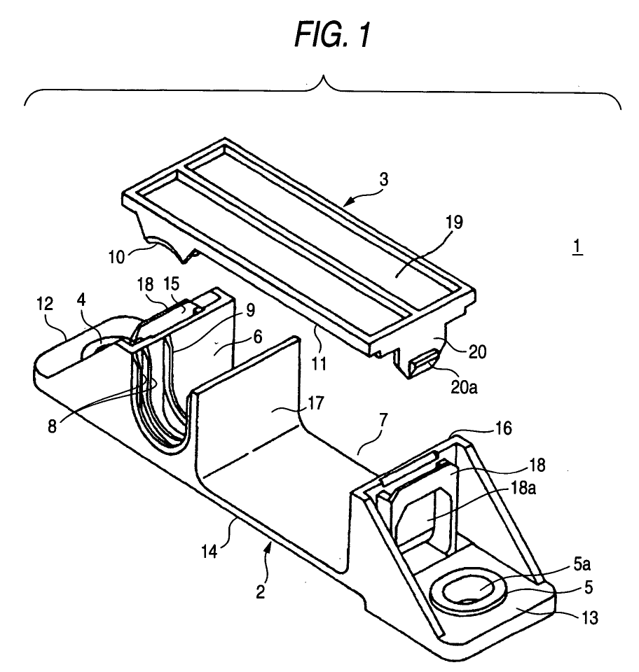

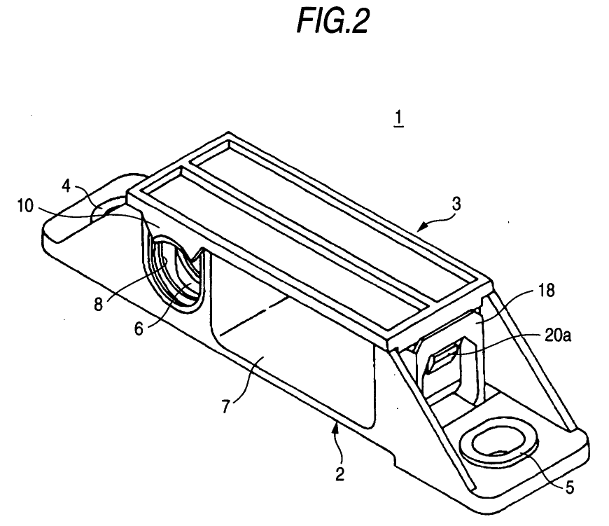

FIGS. 1 and 2 show the harness fixing protector according to a first embodiment of the invention.

The harness fixing protector (called briefly as “protector” hereafter) 1 includes, as shown in FIG. 1, a synthetic resin made base 2, a cover 3, and a pair of metal made or synthetic resin made collars 4, 5. The base 2 has a harness inserting groove (inserting part) 6 and a harness inserting space (inserting part) 7 in parallel. The harness inserting groove 6 is narrow in width for inserting and fixing one piece of wire harness. The harness inserting space is wide in width for inserting two pieces of wire harnesses together. The cover 3 has a brim 10 (projection as the harness fixing portion) for fixing the harness to the harness inserting groove 6 of the base 2 and a flat supporting part 11 for inserting the harness to the harness inserting space 7.

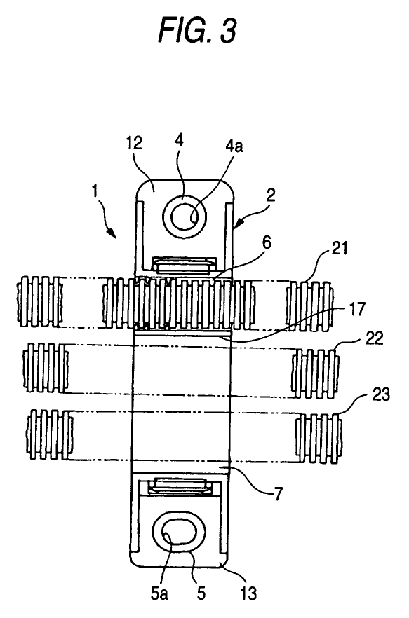

The base 3 has brim shaped brackets (fixing portions) 12, 13 at both end sides transverse with the bracket inserting direction, and one 12 (at the side of the harness inserting groove 6) of the brackets has a circular hole and a ring shaped circular collar 4 fitted in this hole, while the other 13 bracket (at the side of harness inserting space 7) has an oblong hole and a ring shaped oblong collar 5 fitted in the oblong hole. A hole portion (circular hole) 4a (FIG. 3) of the circular collar 4 serves as a basis hole when fixing the protector, and the oblong circular hole portion (oblong hole) 5a of the oblong circular collar 5 serves as a dislocation absorbing hole. A diameter of the circular hole 4a and a short diameter of the oblong hole 5a are equal.

Both brackets 12, 13 continue each other on the same plane surface as an inside horizontal base wall 14, and in adjacency to the respective brackets 12, 13, perpendicular walls 15, 16 stand from the base wall 14, the partition wall 17 stands from the base wall 14 in opposition to the inside of one side wall 15, the harness inserting groove 6 is formed between one side wall 15 and the partition wall 17, the harness inserting groove 6 has a hemi-circular bottom, a pair of U-shaped projections (projections as the harness fixing portion) 8 are formed for fixing the harness at one opened end of the harness inserting groove 6, and the similar projection (projections as the harness fixing portion) 9 is formed at an intermediate part of the harness inserting groove 6 parallel to the projection 8.

The almost rectangular harness inserting space 7 is defined between the partition wall 17 and the other wall 16. There is not the harness fixing portion such as projections 8, 9 in the harness inserting space 7, and the two pieces of wire harnesses are movable in the length direction of the harness within the harness inserting space 7. The harness inserting groove 6 and the harness inserting space 7 are adjacent through the partition wall 17. The partition wall 17 and both walls 15, 16 are at the same height.

Outside of both walls 15, 16, engaging frame pieces 18 of flexibility are provided to the cover 3. The engaging frame pieces 18 stand upward (perpendicularly) from the base wall 14, and have inside engaging holes 18a whose front ends (upper ends) are bendable outside. Between the respective walls 15, 16 and the respective engaging frame pieces 18, spaces are formed for covers to enter into.

The cover 3 has a horizontal cover wall 19 of rectangular plane shape, engaging pawl pieces 20 pending from both ends of short sides of the cover wall 19, and arc shaped brims 10 (projections as the harness fixing portion) for fixing the harness. The brims 10 are placed on the same plane surface as the projections 8 of the base 2.

Each of the engaging pawl pieces 20 has a pawl portion 20a at the outside of a front end, and as shown in FIG. 2, while the pawl portion 20a is entering between the walls 15, 16 (FIG. 1) and the engaging frame piece 18, it engages a hole 18a of the engaging frame piece 18.

In FIG. 1, the arc shaped brim 10 of the cover 3 is positioned in opposition to a half circular bottom of the harness inserting groove 6 of the base 2, and as shown in FIG. 2, the brim 10 is mounted on the harness inserting groove 6 so as to constitute a circular harness fixing portion together with the projections 8 at the side of the base 2. It is preferable to provide the brim also at an intermediate part in the width direction of the cover 3 in opposition to the projection 9 (FIG. 1) at the intermediate part of the harness inserting groove 6.

As shown in FIG. 2, by attaching (closing) the cover 3 on the base 2, the harness inserting groove 6 becomes a harness inserting hole (harness inserting part), and a harness inserting space 7 becomes a rectangular and cylindrical harness inserting hole (harness inserting part).

As shown in FIG. 3 (view of removing the cover 3), a first wire harness 21 is inserted and fixed in the harness inserting part 6 adjacent to the bracket 12 of one side having the circular collar 4 of the protector 1, while a second and third wire harnesses 22, 23 are inserted movably in the length direction in a wide harness inserting part 7 adjacent to the bracket 13 of the other side.

The first wire harness 21 is fixed immovably in the length direction and movably in the circumference direction in that the corrugated tubes on the outer circumference engage at concave grooves (circumferential grooves) with the projections 8 to 10 (FIG. 1). If the first wire harness 21 and the protector 1 are fixed, the protector 1 is positioned with respect to the car body (attaching side), and when wiring the car body as a wire harness assembled body made by the wire harnesses 21 to 23 and the protector 1, the protector 1 is correctly positioned on the car body at desired parts.

Since the second and third wire harnesses 22, 23 are not fixed to the protector 1 but held not to get out, when securing the protector 1 to the car body, the protector 1 is turnable angularly around the collar 4 on the basis of the collar 4 of the bracket 12 of one side adjacent the first wire harness 21 under a condition of temporarily fixing (inserting) to one side stud bolt (not shown) of the car body, and it is possible to pass the other stud bolt (not shown) of the car body through the oblong hole 5a of the collar 5 of the bracket 13 adjacent the third wire harness 23. The same manner is applied when concurrently passing both collars 4, 5 through both stud bolts.

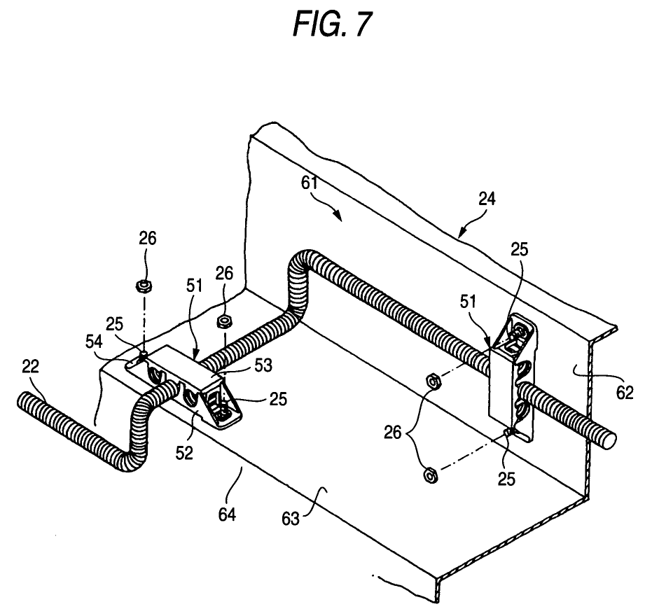

Thereby, the wire harnesses 21 to 23 are bent and wired to the car body (attaching side) as shown in FIG. 7 and even if the bending force or twisting force acts on the wire harnesses 21 to 23 or the protector 1, the protector 1 can be easily and steadily fixed to the car body 24 at good working efficiency.

The protector 1 is tightly fixed to the stud bolts 25 (FIG. 7) by nuts 26. Also when screwing the stud bolts 25 to nuts at the side of the car body, the protector 1 can be easily and steadily fixed in the same as above.

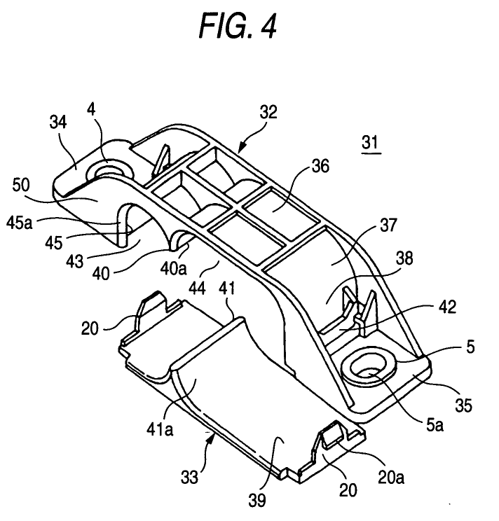

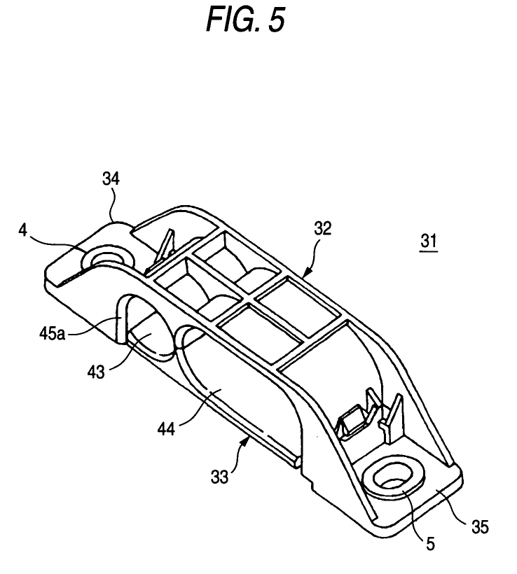

FIGS. 4 and 5 show a second embodiment of the harness fixing protector.

The protector 31 is, as shown in FIG. 4, furnished with the brackets (fixing portions) 34, 35 not on the same face as the horizontal base wall 36 of the base 32 but at front ends (lower ends) of both walls 38 pending through curved parts 37 at both sides of the base wall 36. The base 32 and the cover 33 are disposed by turning over the first embodiment of the protector 1 of FIG. 1 and provided with half-divided partition walls 40, 41 to the base wall 36 of the base 32 and the cover wall 39 of the cover 33 in opposition up and down. Other structures are almost the same as those of the protector of FIG. 1.

At both ends of the cover 33, the engaging pawl pieces 20 stand, and engaging walls 42 are provided on the base 32 outside of the walls 38 of both sides via the entering spaces of the engaging pawl pieces 20. The brackets 34, 35 horizontally continue from the outsides of both upright walls 38, and one sided bracket 34 at the side of the harness inserting groove 43 has the circular collar 4, while another bracket 35 at the side of the wide harness inserting space 44 has the oblong collar 5. The protector 31 is turnable in the long diameter direction of the oblong hole 5a of the other collar 5 around the one sided collar 4 under the condition of setting up the wire harness (not shown).

The partition walls 40, 41 of the base 32 and the cover 33 have curved faces 40a, 41a at both sides, enabling to stably support the wire harness (not shown). The base wall 36 of the base 32 is curved following the curve of the partition wall 40. The brim 45 is provided as the harness fixing portion at one end of a harness receiving groove 43 of the base 32, and the cover 33 does not have the brim.

By the way, it is also effective not to provide the brim 45 in the example of FIG. 4 but to form a taper or a curved guiding slope 45a continuing to the wall 50 at an opening end of the harness inserting groove 43, and to continue the guiding slope 45a to the circumferential face of the harness inserting groove 43 without step difference. According to this structure, the circumferential groove of the corrugated tubes on the outer circumference of the wire harness is not hooked or rubbed by the opening end (edge) of the harness inserting groove 43, whereby the wire harness can be smoothly moved in the diametrical length direction along the guiding slope 45a while the wire harness is bended in a diameter direction of the wire harness so as to have a L shape. Further, it is possible to provide a projected harness fixing portion for only the cover 33.

Under an assembling condition of FIG. 5, the cover 33 is positioned almost at the same surface as the brackets 34, 35 of the base 32, and when fixing the brackets 34, 35 to the car body, the brackets 34, 35 approach to or contact the car body, thereby to prevent disconnection. The first wire harness is fixed to the harness inserting part 43 almost circular in the vertically cross section, while the second and third wire harnesses are supported movably in the length direction in the harness inserting part 44 almost oblong or rectangular in vertically cross section. The working effects by these structures are similar to those of the above mentioned embodiment. If the harness fixing portion 45 is not provided, the wire harness can be freely moved in the length direction along the harness inserting groove 43.

In each of the above mentioned embodiments, it is possible to substitute another protective tube without concave and convex for the corrugated tubes on the outer circumference of the wire harness, and press to secure the protective tube by the projections 8, 10, 45 which are the harness fixing portions. Further, it is also possible to use oblong and circular corrugated tubes not circular in cross section. In this case, one side harness inserting parts 6, 43 are, of course, oblong in cross section.

The number of the wire harnesses inserted in the harness inserting parts 7, 44 wide in width is not limited to two pieces but may be one, three pieces or more. In case of one piece, the inserting part is not wide in width but may be of the same width as that of the harness inserting parts 6, 43 for fixing the harness. Preferably, the number of the wire harness inserted in the harness inserting parts 6, 43 narrow in width is one piece, but in case the wire harnesses are many in the harness inserting parts 7, 44 wide in width, around two pieces are also available.

It is also possible that the other oblong circular collar 5 at the side of absorbing dislocation is made circular with respect to one side circular collar 4 which is an attaching basis. Although the other collar 5 is circular, since the protectors 1, 31 may be revised in position so as to fluctuate on the basis of one side collar 4, the protectors 1, 31 are easily attached to the car body.

It is also possible to directly insert bolts into the holes of the brackets 12, 13 and 34 to 35, not using the collars 4, 5. In this case, a shape of the hole of the bracket is a combination of circle—oblong or circle—circle. The bolts are not inserted in the holes 4a, 5a, but it is also possible insert such as engaging clips as other fixing members thereinto for securing the protectors 1, 31 to the car body.

Substituting for engaging both ends of the covers 3, 33 to the bases 2, 32 by engaging instruments, any one end of the covers 3, 33 may be connected the bases 2, 32 by means of hinges (not shown). As the engaging instrument, no limit is made to the engaging pawl piece 20 and the engaging frame piece 18, but various combinations such as the engaging projections and the engaging holes are applicable.

Not limiting the above mentioned protectors 1, 31 to the car body, the protector according to the invention may be usefully employed when wiring the wire harness to other attaching parts of the machinery.

1. A harness fixing protector, comprising:
a base member, which has fixing portions for fixing the base member to an attachment portion at both ends thereof; and
a cover member, which is attached to the base member;
wherein the base member has:
a first harness inserting portion for inserting and fixing a first wire harness; and
a second harness inserting portion for holding a second wire harness so as to allow a movement of the second wire harness in a length direction thereof.

2. The harness fixing protector as set forth in claim 1, wherein the first harness inserting portion has a harness fixing portion to fix the first wire harness.

3. The harness fixing protector as set forth in claim 1, wherein the second harness inserting portion, through which a plurality of wire harnesses is passed, is greater than the first harness inserting portion in width.

4. The harness fixing protector as set forth in claim 1, wherein the first harness inserting portion and the second harness inserting portion are adjacent through a partition wall.

5. The harness fixing protector as set forth in claim 1, wherein the first harness inserting portion is a groove;
wherein the cover member has a harness fixing portion which is opposed to the groove.

6. The harness fixing protector as set forth in claim 2, wherein the harness fixing portion is a projection which is engaged with a circumferential groove of a corrugated tube of the wire harness.

7. The harness fixing protector as set forth in claim 5, wherein the harness fixing portion is a projection which is engaged with a circumferential groove of a corrugated tube of the wire harness.

8. The harness fixing protector as set forth in claim 1, wherein one of the fixing portions at the side of the first harness inserting portion has a circular hole; and
wherein the other fixing portion at the side of the second harness inserting portion has a oblong hole.
